(19) United States
(12) Patent Application Publication
(10) Pub. No.: US 2008/0126166 A1
(43) Pub. Date: May 29, 2008

(54) System-design support program and method

(75) Inventors: Daisaku Takahashi, Kawasaki (JP); Hiroki Nakatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 11/819,313

(22) Filed: Jun. 26, 2007

Related U.S. Application Data
(63) Continuation of application No. PCT/JP04/19608, filed on Dec. 28, 2004.

(51) Int. Cl. G06Q 10/00

(52) U.S. Cl. 705/8; 705/7

(57) ABSTRACT

A system-design support program and method capable of visualizing costs necessary for system creation and maintenance in an easy-to-understand manner. When a function-selection receiving means receives functions selected and input, to be applied to a computer system, a resource output means refers to a resource information table which has resource information that includes the fixed cost and variable cost of each resource, to output a list of resource information related to resources available for implementing the selected functions. Next, when a resource-selection receiving means receives resources selected and input, to be employed in the computer system to be created, from the list, outputted by the resource output means, a cost output means sums up the fixed costs and variable costs of the selected resources to indicate the fixed cost and variable cost of the computer system to be created.

This application is a continuing application, filed under 35 U.S.C. §111(a), of International Application PCT/JP2004/19608, filed Dec. 28, 2004.

### BACKGROUND OF THE INVENTION

1. Field of the Invention

The present invention relates to system-design support programs and methods for supporting designing computer systems, and particularly to a system-design support program and method for supporting system design in response to detailed requests of a client.

2. Description of the Related Art

When organizations such as companies introduce large-scale computer systems, they demand that the systems can implement, at the minimum cost, functions which users desire. In other words, system designers need to design systems that can efficiently implement as many functions as possible with a few physical resources.

For this purpose, a simulator has been examined (for example, see Japanese Unexamined Patent Application Publication No. 2003-101537) that has a function to select units necessary for a computer system, a function to generate a network configuration diagram in which a network is formed of the selected units, and a function to evaluate the generated network configuration diagram.

A network management system has also been examined (for example, see Japanese Unexamined Patent Application Publication No. 5-225104) that has a data base for storing information corresponding to a computer and network units; generates, from each piece of the information, a specification diagram of a network which satisfies user requests; and checks if the network specification satisfies physical elements.

When a client introduces a computer system, apparatuses to be employed are determined according to the cost-effectiveness of the computer system. The total cost imposed by the introduction of the computer system on the client is broadly divided into an introduction cost (fixed cost) and a running cost (variable cost).

Since the variable cost may change due to the operation plan (such as the frequency of data backups) of the computer system after the system is structured or for some reason, a cost indicated in advance in a catalog or the like cannot necessarily applied to the system of each client.

### SUMMARY OF THE INVENTION

In view of the foregoing points, the present invention has been made. It is an object of the present invention to provide a system-design support program and method capable of visualizing the costs required for the creation and maintenance of a system in an easy-to-understand manner.

To solve the above problems, this invention intends to provide a computer-readable recording medium having computer-executable instructions for performing steps for supporting design of a computer system, the steps comprising: receiving a function selected and input, to be applied to the computer system; extracting resource information related to a resource available for implementing the selected function from a resource information table, the resource information table having resource information that includes the fixed cost and variable cost of each resource; receiving a resource selected and input, to be employed in the computer system to be created, from the extracted resource information; and summing up the fixed cost and variable cost of the selected resource information to indicate the fixed cost and variable cost of the computer system to be created.

Further, to solve the above problems, this invention intends to provide a computer-based method for supporting design of a computer system, comprising the steps of: receiving a function selected and input, to be applied to the computer system; extracting resource information related to a resource available for implementing the selected function from a resource information table, the resource information table having resource information that includes the fixed cost and variable cost of each resource; receiving a resource selected and input, to be employed in the computer system to be created, from the extracted resource information; and summing up the fixed cost and variable cost of the selected resource information to indicate the fixed cost and variable cost of the computer system to be created.

The above and other objects, features and advantages of the present invention will become apparent from the following description when taken in conjunction with the accompanying drawings which illustrate preferred embodiments of the present invention by way of example.

### BRIEF DESCRIPTION OF DRAWINGS

FIG. 1 is a view showing an outline of a present embodiment.

FIG. 2 is a view showing an example structure of a system according to an embodiment of the present invention.

FIG. 3 is a view showing an example hardware structure of a computer used in the present embodiment.

FIG. 4 is a block diagram showing a system-design support function.

FIG. 5 is a view showing an example data structure of a client information table.

FIG. 6 is a view showing an example data structure of a product information table.

FIG. 7 is a view showing an example data structure of a service information table.

FIG. 8 is a view showing an example data structure of a creation-cost information table.

FIG. 9 is a view showing an example data structure of a model-change information table.

FIG. 10 is a view showing an example of a system estimate screen.

FIG. 11 is a view showing an example of a unit selection screen.

FIG. 12 is a flowchart showing a cost estimation procedure.

FIG. 13 is a flowchart showing a procedure of a unit selection process.

FIG. 14 is a view showing an example of the unit selection screen obtained after the unit is changed.

FIG. 15 is a flowchart showing a procedure of a simulation process.

FIG. 16 is a view showing a system estimate screen obtained after simulation.

FIG. 17 is a view showing an example estimate of the entire system.

FIG. 18 is a view showing example detailed estimates.

### DESCRIPTION OF THE PREFERRED EMBODIMENTS

A preferred embodiment of the present invention will be described below by referring to the accompanying drawings.

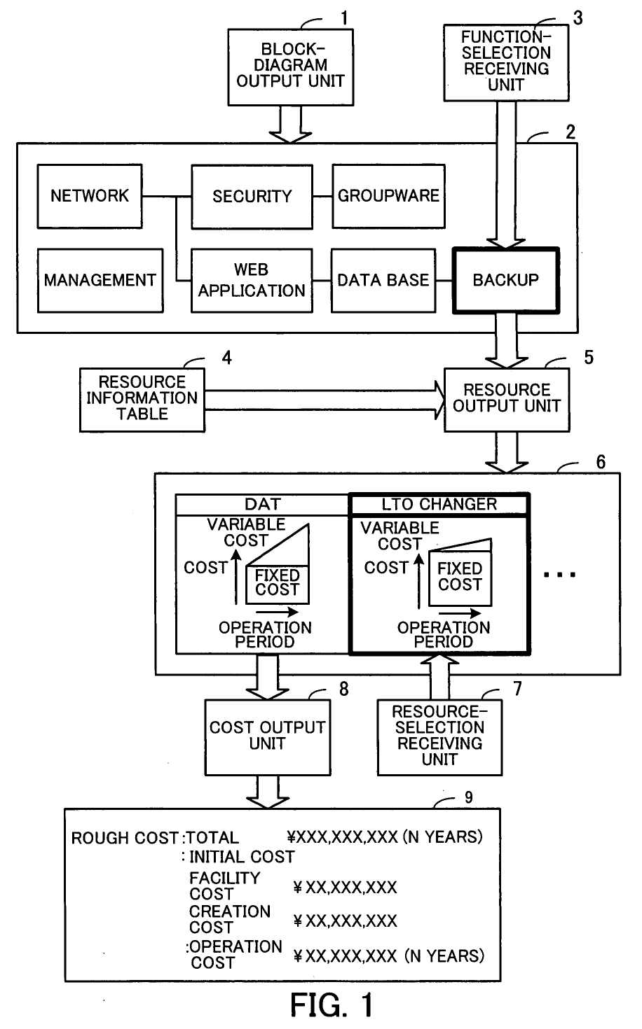

FIG. 1 is a view showing an outline of the present embodiment. As shown in FIG. 1, the present embodiment includes a block-diagram output unit 1, a function-selection receiving unit 3, a resource information table 4, a resource output unit 5, a resource-selection receiving unit 7, and a cost output unit 8.

The block-diagram output unit 1 outputs a block diagram 2 showing functions constituting a computer system, by a plurality of functional blocks. For example, the block-diagram output unit 1 receives inputs of basic parameters (such as an estimated order amount and a backup amount) from the user and outputs the block diagram 2 formed of functional blocks corresponding to the basic parameters.

The function-selection receiving unit 3 receives functions selected and input, to be applied to the computer system. Specifically, the function-selection receiving unit 3 receives desired functional blocks selected and input from the block diagram 2, outputted by the block-diagram output unit 1.

The resource output unit 5 refers to the resource information table 4, which has resource information that includes the fixed cost (cost for creating the computer system) and the variable cost (cost for maintaining the computer system) of each resource, to output a list 6 of resource information related to resources available for implementing the selected functions. The list 6 shows, for example, the fixed cost and variable cost of each resource by a graph with the vertical axis indicating the cost (total cost of the fixed cost and variable cost) and the horizontal axis indicating the operation period.

The resource-selection receiving unit 7 receives resources selected and input, to be employed in the computer system to be created, from the list 6, outputted by the resource output unit 5. The cost output unit 8 sums up the fixed costs and variable costs of the selected resources to indicate a rough cost 9 that includes the fixed cost and variable cost of the computer system to be created. For example, the rough cost 9 includes a total cost in a predetermined period, an initial cost, and an operation cost. The initial cost is divided into a facility cost and creation cost (work cost for creating the computer system).

With the above-described units, first, the block-diagram output unit 1 outputs the block diagram 2. The function-selection receiving unit 3 receives functions selected and input, to be applied to the computer system, from the functional blocks shown in the block diagram 2. Then, the resource output unit 5 refers to the resource information table 4, which has resource information that includes the fixed cost and variable cost of each resource, to output the list 6 of resource information related to resources available for implementing the selected functions. Next, when the resource-selection receiving unit 7 receives resources selected and input, to be employed in the computer system to be created, from the list 6, outputted by the resource output unit 5, the cost output unit 8 sums up the fixed costs and variable costs of the selected resources to indicate the fixed cost and variable cost of the computer system to be created.

In this way, the cost (fixed cost) for creating the computer system and the cost (variable cost) for maintaining the system can be visualized. As a result, a computer system having high cost-effectiveness with the system creation cost and operation cost being taken into account can be easily selected at a stage of business talk for system creation.

Details of the present embodiment of the present invention will be described next.

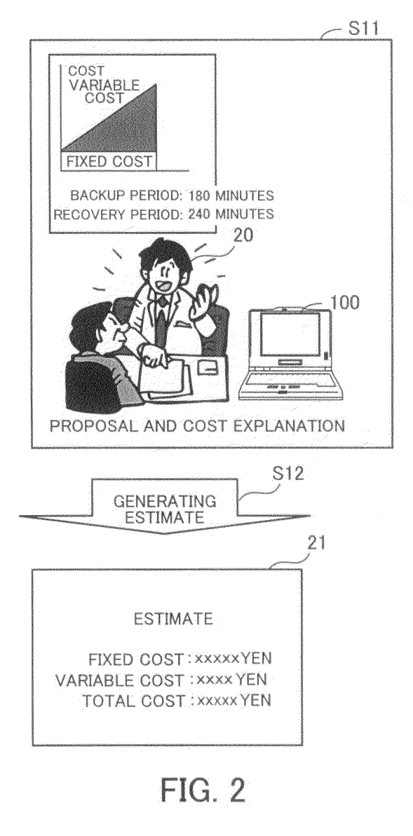

FIG. 2 is a view showing an example system configuration according to the present embodiment of the present invention. A service engineer (SE) 20 serving as a system integrator uses a portable computer 100, such as a notebook-type personal computer, to propose a computer system and explain the cost thereof to a person in charge of a client company (step S11). The SE 20 uses the computer 100 to show to the client a graph indicating the functions and cost (fixed cost and variable cost) of the computer system proposed according to client requests. The SE 20 also explains risk (such as a backup period and recovery period of a backup unit) imposed when each unit is employed, by outputting it on the screen of the computer 100. When the client agrees with the introduction of the proposed system, the SE 20 generates and prints an estimate 21 of the system by the computer 100 (step S12).

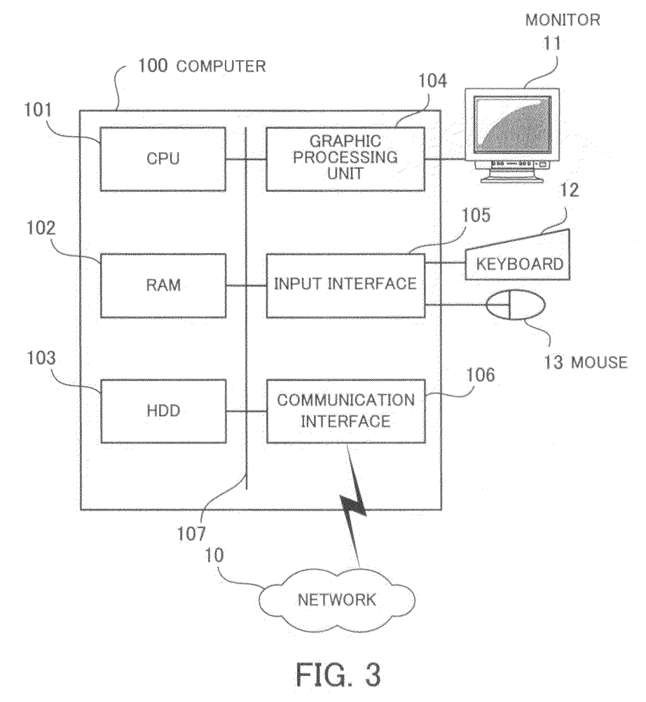

FIG. 3 is a view showing an example hardware structure of the computer used in the present embodiment.

The whole of the computer 100 is controlled by a CPU (central processing unit) 101. The CPU 101 is connected to a RAM (random access memory) 102, a hard-disk drive (HDD) 103, a graphic processing unit 104, an input interface 105, and a communication interface 106, through a bus 107.

The RAM 102 temporarily stores at least a part of an OS (operating system) program and an application program to be executed by the CPU 101. The RAM 102 also stores various types of data necessary for processing executed by the CPU 101. The HDD 103 stores the OS and application program.

The graphic processing unit 104 is connected to a monitor 11. The graphic processing unit 104 outputs an image on the screen of the monitor 11 according to an instruction of the CPU 101. The input interface 105 is connected to a keyboard 12 and a mouse 13. The input interface 105 sends a signal sent from a keyboard 12 or a mouse 13, to the CPU 101 through the bus 107.

The communication interface 106 is connected to a network 10. The communication network 106 exchanges data with another computer through the network 10.

With the above-described hardware structure, processing functions of the present embodiment can be implemented.

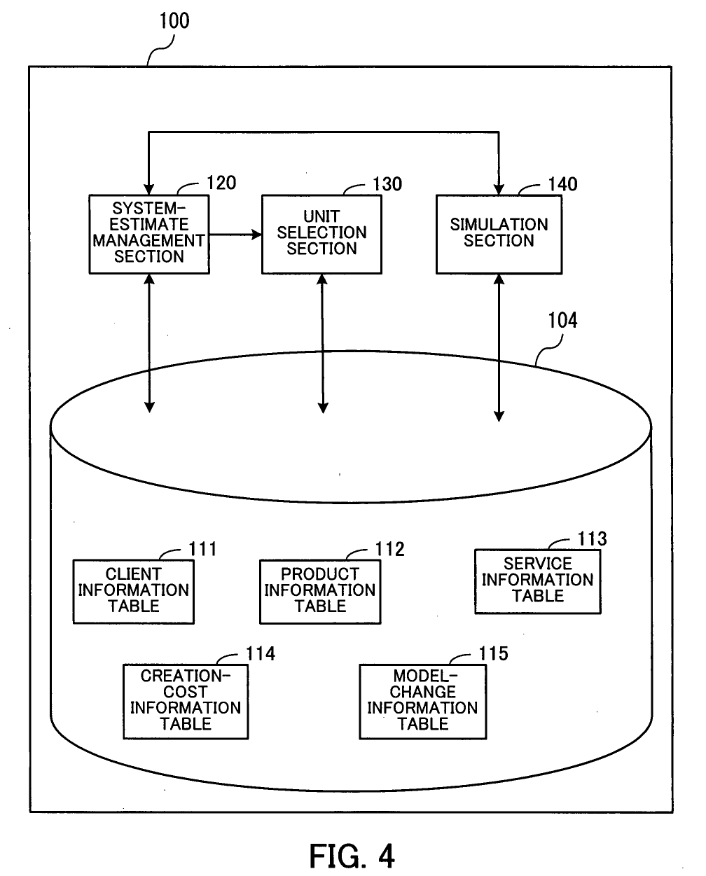

FIG. 4 is a block diagram showing a system-design support function. The HDD 103 of the computer 100 stores a client information table 111, a product information table 112, a service information table 113, a creation-cost information table 114, and a model-change information table 115.

The client information table 111 is a data table for client-information management. For example, the client information table 111 registers basic parameters such as performance necessary for the computer system to be created.

The product information table 112 is a data table that registers information related to products (which includes hardware resources and software resources) serving as components of the system. The service information table 113 is a data table that registers information related to operation and management services performed after the system is created. The creation-cost information table 114 is a data table that registers information related to a work cost required for creating the system. The model-change information table 115 is a data table that registers information related to a candidate product to be used when the model of a certain apparatus is changed from a basic system configuration.

To support designing a system by using various types of information stored in the HDD 103, the computer 100 is provided with a system-estimate management section 120, a unit selection section 130, and a simulation section 140.

The system-estimate management section 120 manages the entire process of system-estimate generation. Specifically, the system-estimate management section 120 outputs a block diagram indicating the functions of the system configuration according to basic parameters input by the user. When a function is selected from the functional blocks, the system-estimate management section 120 activates the unit selection section 130. When a request for simulating the cost calculation of the entire system is received, the system-estimate management section 120 activates the simulation section 140. The system-estimate management section 120 outputs the result of the cost calculation made by the simulation section 140, on the screen.

The unit selection section 130 outputs a list of products which can be used to implement the selected function and receives products selected and input from the list, to be employed in the system. At that time, the unit selection section 130 outputs a graph showing the fixed cost and variable cost of each unit with the vertical axis indicating the total cost and the horizontal axis indicating the operation period.

The simulation section 140 calculates a rough cost of a system created by combining the units selected by the unit selection section 130. The cost is calculated for the fixed cost (initial cost) and the variable cost (operation cost).

Data registered in the various information tables shown in FIG. 4 will be described next in detail.

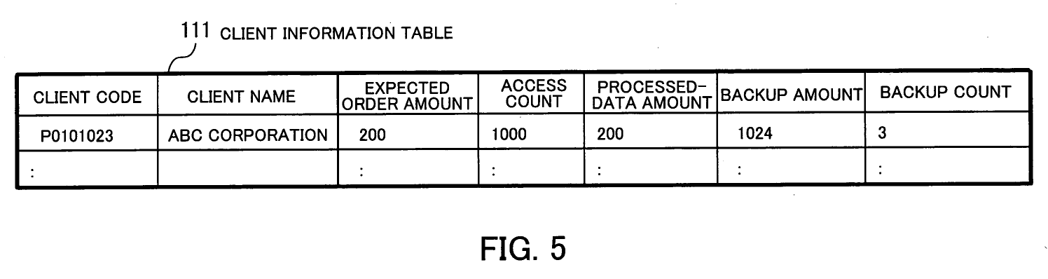

FIG. 5 is a view showing an example data structure of the client information table. The client information table 111 includes fields of a client code, a client name, an expected order amount, an access count, a processed-data amount, a backup amount, and a backup count. Data items listed horizontally are associated with each other and form a record of client information.

The client-code field includes the identification number of a client. The client-name field includes the name of the client. The expected-order-amount field includes an order amount in units of ten thousand yen. The access-count field includes an expected value of the maximum simultaneous access count in the system to be introduced at the client. The processed-data-amount field includes the total amount of data processed in a unit time in the system to be introduced at the client, in units of gigabytes (GB). The backup-amount field includes a data amount to be backed up periodically in the system to be introduced at the client, in units of megabytes (MB). The backup-count field includes the number of times a backup is made within a predetermined period (for example, one day) in the system to be introduced at the client.

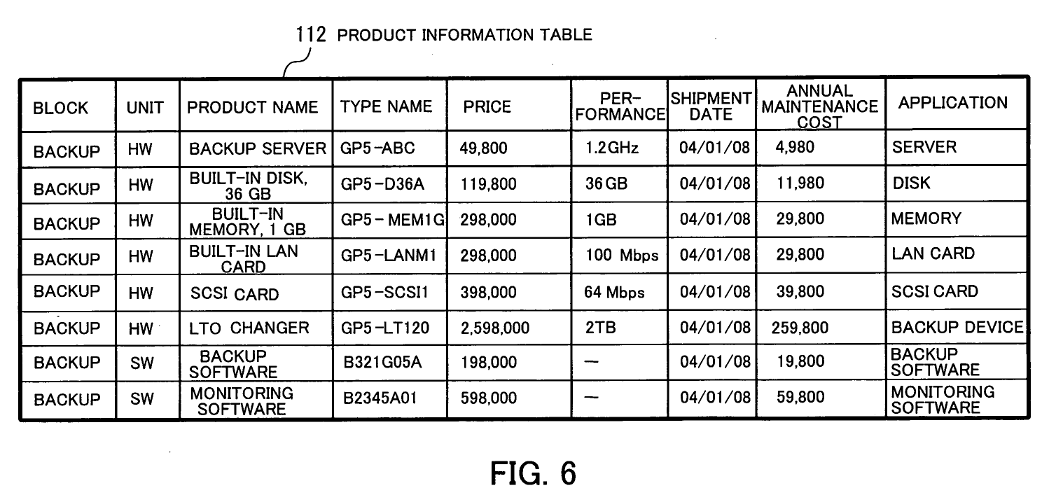

FIG. 6 is a view showing an example data structure of the product information table. The product information table 112 includes fields of a block, a unit, a product name, a type name, a price, performance, a shipment date, an annual maintenance cost, and an application. Data items listed horizontally are associated with each other and form a record of product information.

The block field includes the name of a functional block indicating a function to be introduced in the system. The unit field indicates whether a resource which can be used to implement the function is a hardware resource (HW) or a software resource (SW). The product-name field includes a general name of the resource, which can be used to implement the function. The type-name field includes the product type name of the resource, which can be used to implement the function. The price field includes the sales amount of the resource, which can be used to implement the function. The performance field includes performance related to a typical function of the resource, which can be used to implement the function. The shipment-date field includes the date of shipment of the resource, which can be used to implement the function. The annual-maintenance-cost field includes a cost required to annually maintain the resource, which can be used to implement the function. The application field includes an application of the resource, which can be used to implement the function.

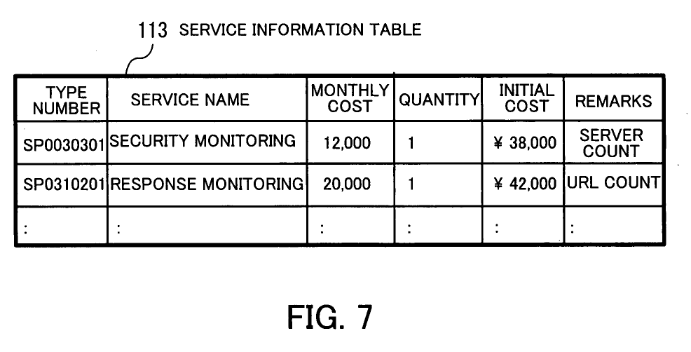

FIG. 7 is a view showing an example data structure of the service information table. The service information table 113 includes fields of a type number, a service name, a monthly cost, a quantity, an initial cost, and remarks. Data items listed horizontally are associated with each other and form a record of service information.

The type-number field includes the identification information of a service. The service-name field includes the name of the service. The monthly-cost field includes a monthly billing amount imposed when a service contract is made. The quantity field includes the number of apparatuses to be serviced in a service unit. The initial-cost field includes a cost required to introduce the resources to which initial investment is to be made, in the client system upon provision of the service. The remarks field includes a supplementary description related to the service.

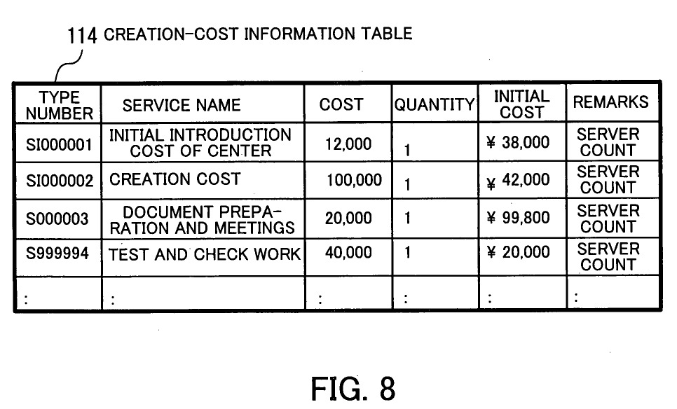

FIG. 8 is a view showing an example data structure of the creation-cost information table. The creation-cost information table 114 includes fields of a type number, a service name, a cost, a quantity, an initial cost, and remarks. Data items listed horizontally are associated with each other and form a record of creation-cost information.

The type-number field includes the identification information of work (service) required for system creation. The service-name field includes the name of the service, required for system creation. The cost field includes a billing amount required when the service is provided. The quantity field includes the number of apparatuses to be serviced in a service unit. The initial-cost field includes the cost required to introduce the resources to which initial investment to be is made, in the client system upon provision of the service. The remarks field includes a supplementary description related to the service.

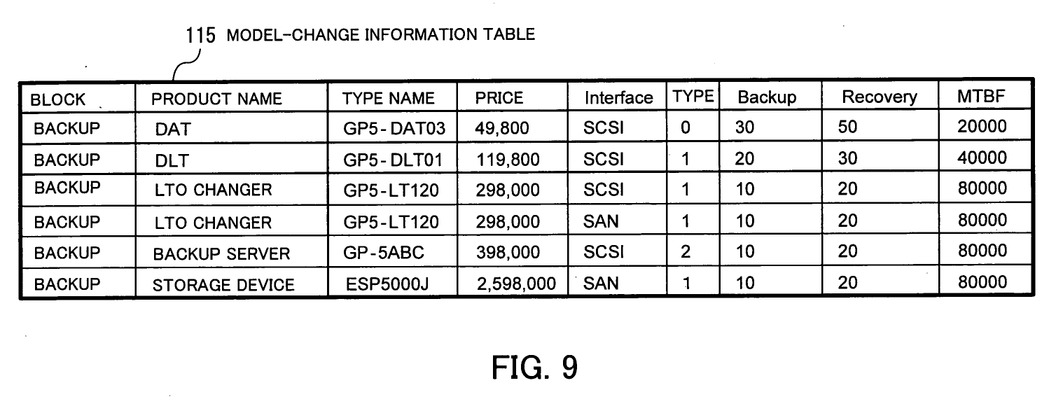

FIG. 9 is a view showing an example data structure of the model-change information table. The model-change information table 115 includes fields of a block, a product name, a type name, a price, an interface, a type, a backup, a recovery, and a MTBF (mean time between failures). Data items listed horizontally are associated with each other and form a record of model-change information.

The block field includes the name of a functional block indicating a function to be introduced in the system. The product-name field includes a general name of a resource which can be used to implement the function. The type-name field includes the product type name of the resource, which can be used to implement the function. The price field includes the sales mount of the resource, which can be used to implement the function. The interface field includes the name of an interface for connecting the resource.

The type field includes a flag indicating the installation type of the apparatus. For example, “0” indicates an apparatus to be included in the computer, “1” indicates an apparatus to be externally attached to the computer, and “2” indicates an apparatus (such as an appliance server) to be introduced together with the computer.

The backup field includes the backup performance (time period required to back up a predetermined amount of data). The recovery field includes the recovery performance (time period required to recover a predetermined amount of data). The MTBF field includes the MTBF value of the apparatus.

According to the structure described above, the computer 100 supports designing the system. The SE 20, who uses the computer 100, first outputs a system-estimate screen on the computer 100.

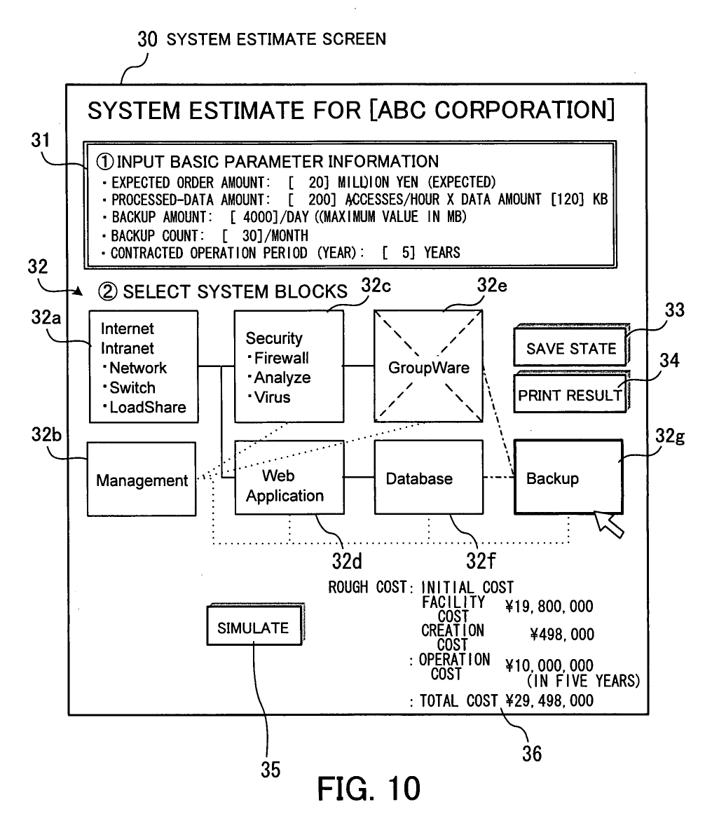

FIG. 10 is a view showing an example system-estimate screen. A system-estimate screen 30 includes a basic-parameter input section 31, a system-block-selection section 32, a save state button 33, a print result button 34, a simulate button 35, and a rough-cost output section 36.

The basic-parameter input section 31 is an area for inputting basic parameters indicating a plan of the user for a system to be introduced. In the case shown in FIG. 10, an expected order amount, a processed-data amount, a backup amount, a backup count, and a contracted operation period (year) are outputted as basic parameters.

The expected order amount is an expected cost amount prepared by the user for system introduction. In the case of FIG. 10, a numerical value is input in units of one million yen in the field of the expected order amount.

The processed-data amount is the total amount of data processed in a unit time. In the case of FIG. 10, a numerical value obtained by multiplying the number of accesses per hour by the amount (120 KB) of data processed in one access, in the field of the processed-data amount.

The backup amount is the maximum capacity of data to be backed up in one-day backup processing. In the case of FIG. 10, a backup data amount is input in units of megabytes (MB) in the field of the backup amount.

The backup count is the number of times a backup is performed in a unit period of time. In the case of FIG. 10, a backup count per month is input in the field of the backup count.

The contracted operation period (year) is a contract period for the operation and management. In the case of FIG. 10, a contract period in units of years is input in the field of the contracted operation period (year).

The system-block-selection section 32 outputs a block diagram of functions constituting the system. Each block corresponds to a function serving as a component of the system. When the user selects a desired block, a screen (unit-selection screen) for selecting a unit required to implement the function corresponding to the selected block is outputted. The relationships between functions are indicated by lines connecting the blocks. Solid lines indicate LAN (local area network) connections between functions. Dotted lines indicate maintenance-LAN connections between functions. One-dot chain lines indicate SAN (storage area network) connections between functions.

A block 32a indicates a network-related function. A block 32b indicates an operation-and-management-related function. A block 32c indicates a security-related function. A block 32d indicates a web-application-related function. A block 32e indicates a groupware-related function. A block 32f indicates a data-base-related function. A block 32g indicates a data-backup-related function.

Among the blocks 32a to 32g outputted in the system-block-selection section 32, a cross-out block with x (in the case of FIG. 10, the block 32e) is a function not employed in the proposed system. A block enclosed by a thick line (in the case of FIG. 10, the block 32g) is a block for which a unit is being selected.

The save state button 33 is used to save the contents input to the basic-parameter input section 31 and information indicating a unit selection state performed on the unit selection screen into the HDD 103. The print result button 34 is used to print the system configuration formed of the selected units and the system cost. The simulate button 35 is used to make the simulation section 140 calculate rough values of the fixed cost (initial cost) and variable cost (operation cost) corresponding to the unit selection state.

The rough-cost output section 36 outputs a rough value of the cost based on the selected units. The rough cost value is broadly divided into an initial cost, an operation cost and the total cost. The initial cost is a cost necessary for introducing the system. The initial cost is divided into a facility cost and a creation cost. The facility cost is a cost for purchasing resources introduced into the system. The creation cost is a cost for a service of system introduction work. The operation cost is a cost necessary for operations and management for a predetermined period (in the case of FIG. 10, five years) after the system introduction. The total cost is the sum of the initial cost and the operation cost.

The user inputs basic-parameter information in the basic-parameter input section 31, on the system-estimate screen 30. Next, the user selects a block for which a unit is to be selected, from the functional block diagram outputted on the system-block-selection section 32. Then, a unit-selection screen for the corresponding function is outputted. In the case of FIG. 10, since the backup block 32g is selected, a unit-selection screen indicating a list of units which can be used for backup is outputted.

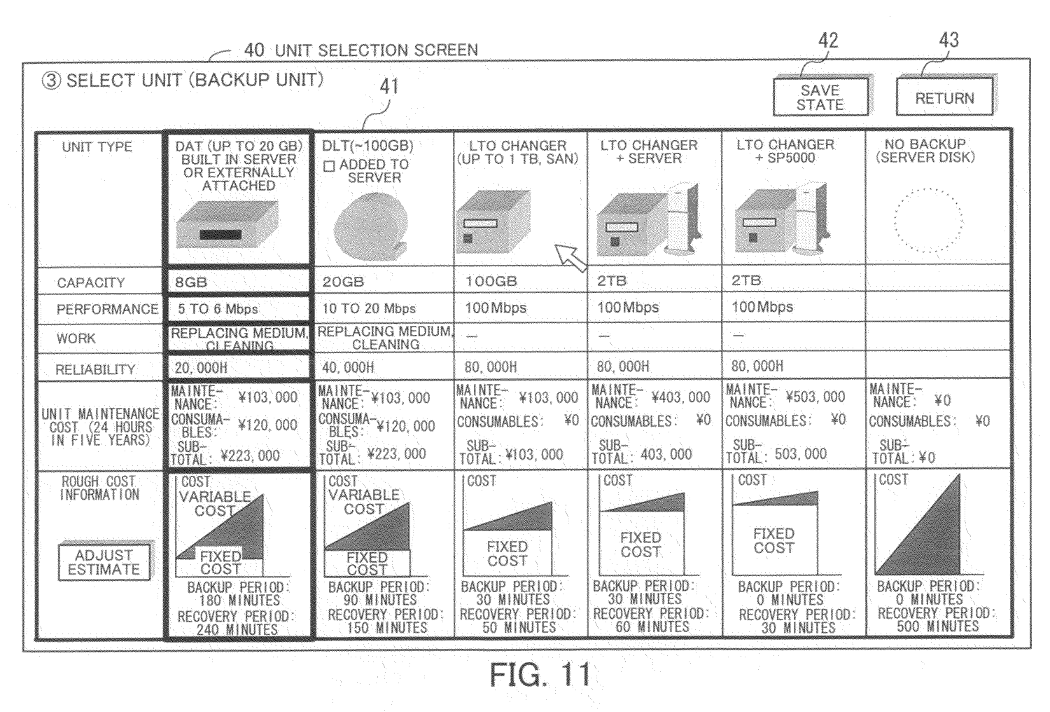

FIG. 11 is a view showing an example unit-selection screen. A unit-selection screen 40 is used to select a unit to implement a function necessary for the system. In the case of FIG. 11, a screen for selecting a backup unit is outputted. The unit-selection screen 40 is provided with a unit-list output section 41, a save state button 42, and a return button 43.

The unit-list output section 41 outputs a list of units which can be selected. The unit-list output section 41 outputs information related to each unit in the fields of a unit type, a capacity, performance, work, reliability, a unit maintenance cost, and rough cost information. In the unit-list output section 41, a unit selected to be employed in the system to be introduced is outputted with emphasis (in the case of FIG. 11, with a thick-line frame being used).

The unit-type field includes the type into which a unit is classified by function. The capacity field includes the storage capacity of the backup unit. When the unit records data in a removable recording medium, the storage capacity of one recording medium is indicated.

The performance field includes the writing speed of the unit per unit time. The work field includes work necessary for operating the unit. The reliability field includes a numerical value (MTBF) indicating the reliability of the unit.

The unit-maintenance-cost field includes a maintenance cost imposed when the unit is supported for 24 hours in five years. The maintenance cost is indicated by the total (subtotal) and its breakdowns, a cost for maintenance work and a cost for consumables.

The rough-cost-information field includes a graph showing the fixed cost and variable cost with the vertical axis indicating the total cost and the horizontal axis indicating the operation period. A period necessary for a backup and a period necessary for a recovery are also indicated. The backup period and recovery period can be calculated according to the backup amount input as a basic parameter.

Specifically, the backup period is obtained in the following way.

Backup period=preparation period+unit working period+(medium replacement period×replacement count)

In the above equation, the preparation period is a work period in which the operator prepares a recording medium and others and is set to a typical value in advance; the unit working period is a period necessary for backing up data having the backup amount and is obtained by dividing the backup amount by the performance (data writing speed); the medium replacement period is a period required for replacing the recording medium and is set in advance to a typical period; and the replacement count is the number of times the recording medium is replaced in one backup and is obtained by subtracting one (corresponding to the recording medium first mounted) from the value (the number of required recording media) acquired by dividing (with the remainder rounded upwards) the backup amount by the recording capacity of the recording medium.

The recovery period is obtained in the following way.

Recovery period=notification period+check period+restored period+business getting-back work period

The notification period is a period from when a failure is detected to when the failure is reported to the maintenance worker and is set to a typical value in advance. The check period is a period in which the maintenance worker checks the failure and is set to a typical value in advance. The restore period is a period for restoring data backed up and is obtained by dividing the backup amount by the performance (data reading speed). The business getting-back work period is a period required to get back to business after the data is restored and is set to a typical value in advance.

With the use of the unit-selection screen 40, described above, the user can select a unit. For example, the user refers to the unit-list output section 41 to specify a desired unit by a mouse pointer with the capacity, performance, cost, and other data items taken into account.

When the simulate button 35, provided for the system-estimate screen 30 (see FIG. 10), is pressed, the simulation section 140 calculates the costs for the system creation and operations according to each unit selected on the unit-selection screen 40. The cost calculation is performed for a facility cost, creation cost, and monthly cost in a division manner. The facility cost is a purchase price paid by the user for the selected unit and is a price after a discount when the discount is available. The creation cost is a cost for work required to install and operate the selected unit.

To determine work to be performed, for example, the user outputs a list of work items on the screen of the computer to select a work item which the user asks the system integrator to perform. The simulation section 140 calculates the creation cost according to the selected work item.

The monthly cost is a cost for services (such as maintenance work, replacing consumables, and work needed when a failure occurs) necessary for improving the reliability of the selected unit and security. To determine work to be performed and necessary consumables, for example, the user outputs a list of services on the screen of the computer to select a service which the user thinks necessary. The simulation section 140 calculates the monthly cost according to the selected service. When a discount is available, the monthly cost is calculated according to a discounted charge. The system-estimate screen 30 reflects the calculated cost.

A procedure of processing for estimating a cost at a system proposal will be described below.

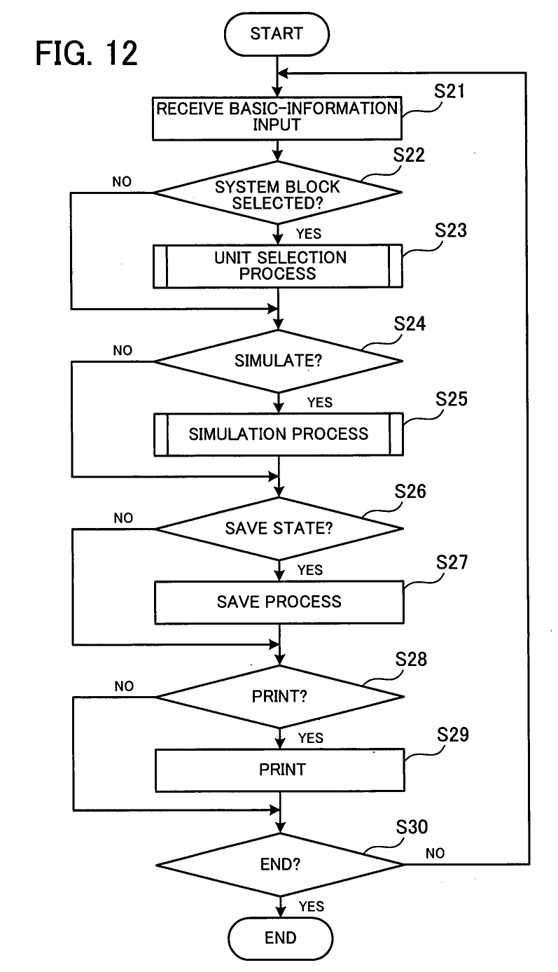

FIG. 12 is a flowchart showing the cost-estimate procedure. The processing shown in FIG. 12 will be described in the order of step numbers.

Step S21: The system-estimate management section 120 receives basic parameters input by the user (or an SE who knows user's desire).

Step S22: The system-estimate management section 120 determines whether a block indicating a function of the system has been selected. When a block has been selected, the system-estimate management section 120 activates the unit selection section 130 and the processing proceeds to step S23. When a block has not been selected, the processing proceeds to step S24.

Step S23: The unit selection section 130 outputs the unit selection screen 40 and performs a unit selection process. Details of the unit selection process will be described later.

Step S24: The system-estimate management section 120 determines whether the simulate button 35 has been pressed. When the simulate button 35 has been pressed, the system-estimate management section 120 activates the simulation section 140 and the processing proceeds to step S25. When the simulate button 35 has not been pressed, the processing proceeds to step S26.

Step S25: The simulation section 140 calculates the fixed cost and variable cost and makes the system-estimate screen 30 reflect the results. Details of this process will be described later.

Step S26: The system-estimate management section 120 determines whether the save state button 33 has been pressed. When the save state button 33 has been pressed, the processing proceeds to step S27. When the save state button 33 has not been pressed, the processing proceeds to step S28.

Step S27: The system-estimate management section 120 saves the current unit-selection state and rough cost in the HDD 103 or others.

Step S28: The system-estimate management section 120 determines whether the print result button 34 has been pressed. When the print result button 34 has been pressed, the processing proceeds to step S29. When the print result button 34 has not been pressed, the processing proceeds to step S30.

Step S29: The system-estimate management section 120 prints the system structure and system-cost estimate.

Step S30: The system-estimate management section 120 determines whether a processing end has been input. When a processing end has been input, the processing is finished. When a processing end has not been input, the processing proceeds to step S21.

Details of the unit selection process, performed on the unit selection screen 40, will be described next.

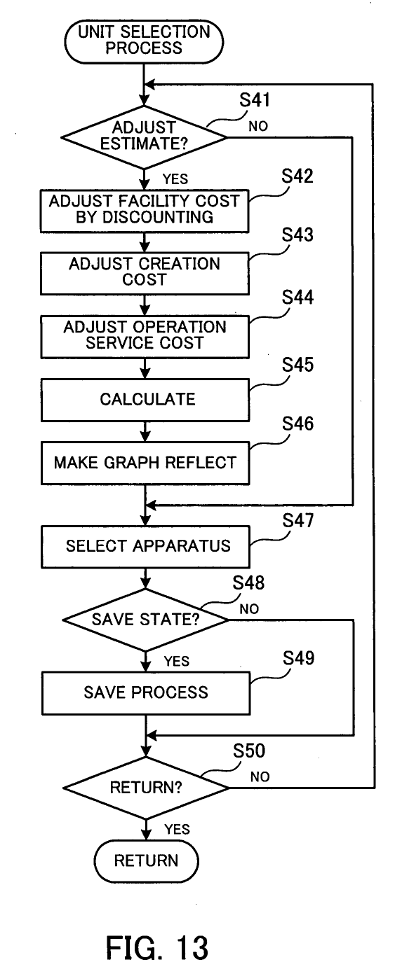

FIG. 13 is a flowchart showing a procedure of the unit selection process. The process shown in FIG. 13 will be described below in the order of step numbers.

Step S41: The unit selection section 130 determines whether the estimate is to be adjusted. When the estimate is to be adjusted, the process proceeds to step S42. When the estimate is not to be adjusted, the process proceeds to step S47.

Step S42: The unit selection section 130 adjusts the basic sales amount of the facility by using a discount or others.

Step S43: The unit selection section 130 adjusts the basic amount of the creation cost by using a discount or others.

Step S44: The unit selection section 130 refers to the service information table 113 to adjust the cost for the operation service by using a discount or others.

Step S45: The unit selection section 130 calculates the fixed cost and variable cost for each unit. The creation cost is obtained by “the initial cost for a corresponding service in the creation-cost information table 114+the cost for each necessary unit×its quantity”. The operation cost is obtained by “the initial cost of a corresponding service in the service information table 113+monthly cost×quantity×60 (months)”.

Step S46: The unit selection section 130 makes the graph reflect the calculation results.

Step S47: The unit selection section 130 extracts records related apparatuses from the product information table 112 and the model-change information table 115, and outputs them in the unit-list output section 41. The unit selection section 130 receives the selection and input of an apparatus to be employed in the system, from the list of the extracted units.

Step S48: The unit selection section 130 determines whether the save state button 42 has been pressed. When the save state button 42 has been pressed, the process proceeds to step S49. When the save state button 42 has not been pressed, the process proceeds to step S50.

Step S49: The unit selection section 130 saves the current unit-selection state and a rough cost of each apparatus in the HDD 103 or others.

Step S50: The unit selection section 130 terminates the unit selection screen 40, and determines whether an instruction to return to the system estimate screen 30 has been input. When the instruction has been input, the unit selection process ends. When the instruction has not been input, the process proceeds to step S41.

In this manner, unit selection is performed. Every time when the service contents in the operations are changed, the fixed cost (initial cost) and variable cost (operation cost) are calculated again according to the service costs.

For example, in the state shown in the unit selection screen 40 of FIG. 11, a DAT (digital audio tape) has been selected as a backup unit. The DAT needs a long backup or recovery time, requiring a long work time. If a long work time is taken in a backup or the like, other business processes are delayed or the next business start time is delayed, making a great influence on business. When the initial cost is increased to select an apparatus capable of a shorter backup or recovery, a system having a high operation efficiency can be created.

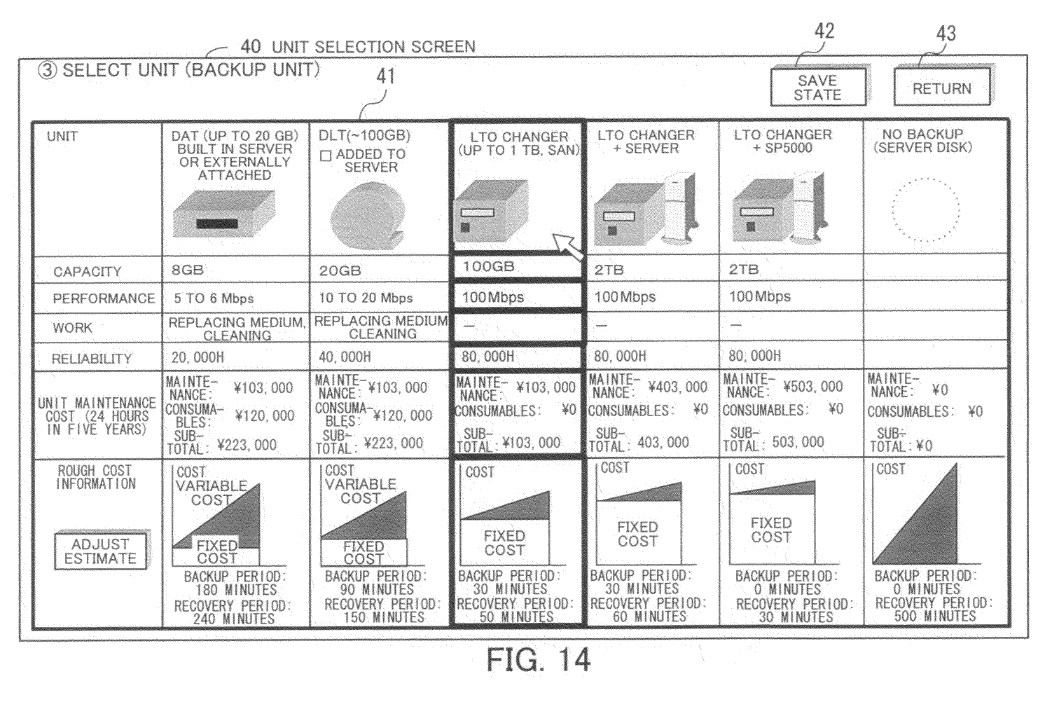

FIG. 14 is a view showing an example unit-selection screen outputted after the unit is changed. In the case of FIG. 14, the selected unit is changed from the DAT to an LTO (liner tape-open) changer on the unit selection screen 40. The LTO changer is more expensive than the DAT, but the operation cost thereof is lower than that of the DAT. Therefore, when a long operation is planned, it is understood that the total cost within a predetermined period from the system introduction is lower. In addition, the LTO changer can perform a backup or restoration at higher speed than the DAT. In other words, a higher-performance system can be introduced at a lower cost.

When the simulate button 35 is pressed on the system estimate screen 30 after the unit is changed in this way, a simulation process is performed.

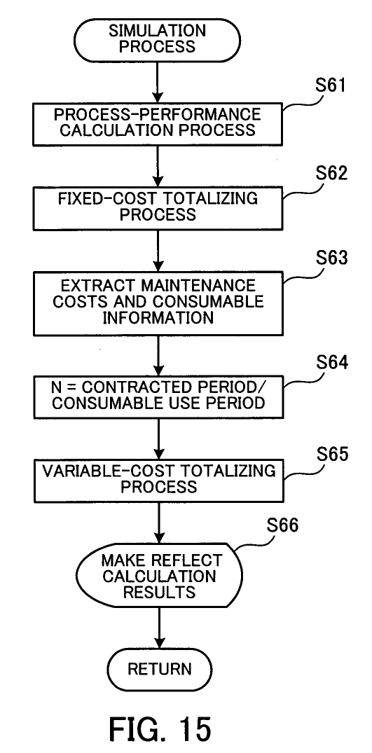

FIG. 15 is a flowchart showing a procedure of the simulation process. The process shown in FIG. 15 will be described below in the order of step numbers.

Step S61: The simulation section 140 calculates process performance. Specifically, the simulation section 140 refers to the model-change information table 115 to calculate CPU process performance, backup process performance, and others from the basic parameters.

Step S62: The simulation section 140 performs a fixed-cost totalizing process. Specifically, the simulation section 140 refers to the product information table 112 and the service information table 113 to totalize the facility cost, creation cost, service initial cost, and other costs.

Step S63: The simulation section 140 extracts maintenance costs and consumable information. Specifically, the simulation section 140 refers to the product information table 112 and the service information table 113 to extract the maintenance cost of each facility and information of consumables (such as recording media).

Step S64: The simulation section 140 calculates the number N (N: natural number) of consumables necessary within the contracted period. The number N of consumables is calculated according to the life (consumable use period) of each consumable. Specifically, the simulation section 140 calculates a necessary count for each consumable by an equation, N=contracted period/consumable use period.

Step S65: The simulation section 140 totalizes variable costs. Specifically, the simulation section 140 refers to the service information table 113 to calculate a monthly service cost, monthly maintenance cost, and consumable purchase cost (consumable unit price×N). The sum of the calculated costs is the operation cost.

Step S66: The simulation section 140 makes the rough-cost output section 36 on the system estimate screen 30 reflect the calculation results.

The simulation process is performed in this manner to update the rough-cost values on the system estimate screen 30.

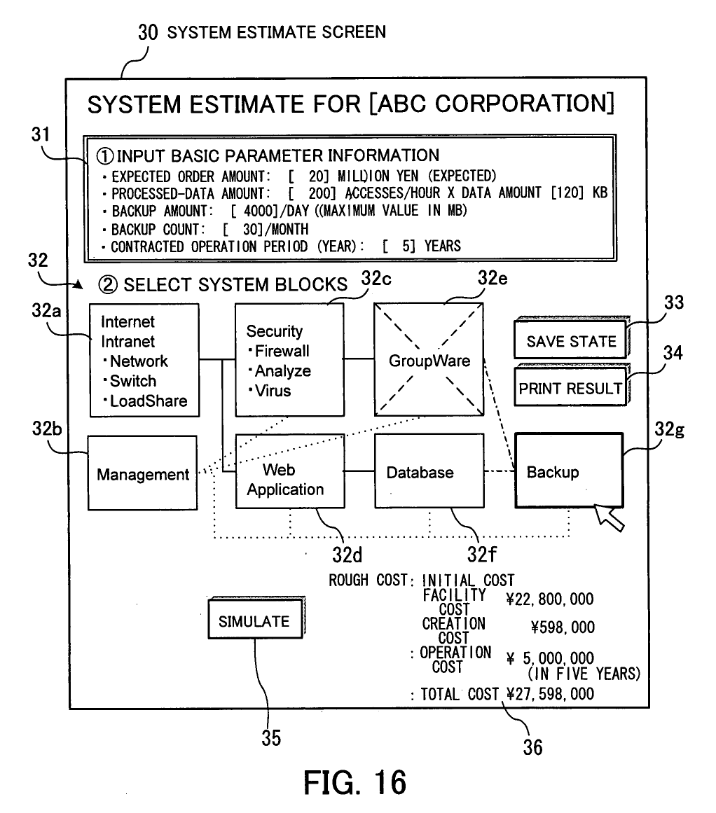

FIG. 16 is a view showing a system estimate screen obtained after the simulation. On the system estimate screen obtained after the simulation, the values in the rough-cost output section 36 have been updated. When the values are compared with those in the state before the simulation, shown in FIG. 10, it is understood that the initial cost is increased but the operation cost is reduced by more than the increase in the initial cost. As a result, the total cost is reduced.

When the print result button 34 is pressed on the system estimate screen 30, an estimate of the proposed system is printed. For example, a unit list and detailed estimates for the creation cost and operation cost are printed in addition to the entire-system estimate.

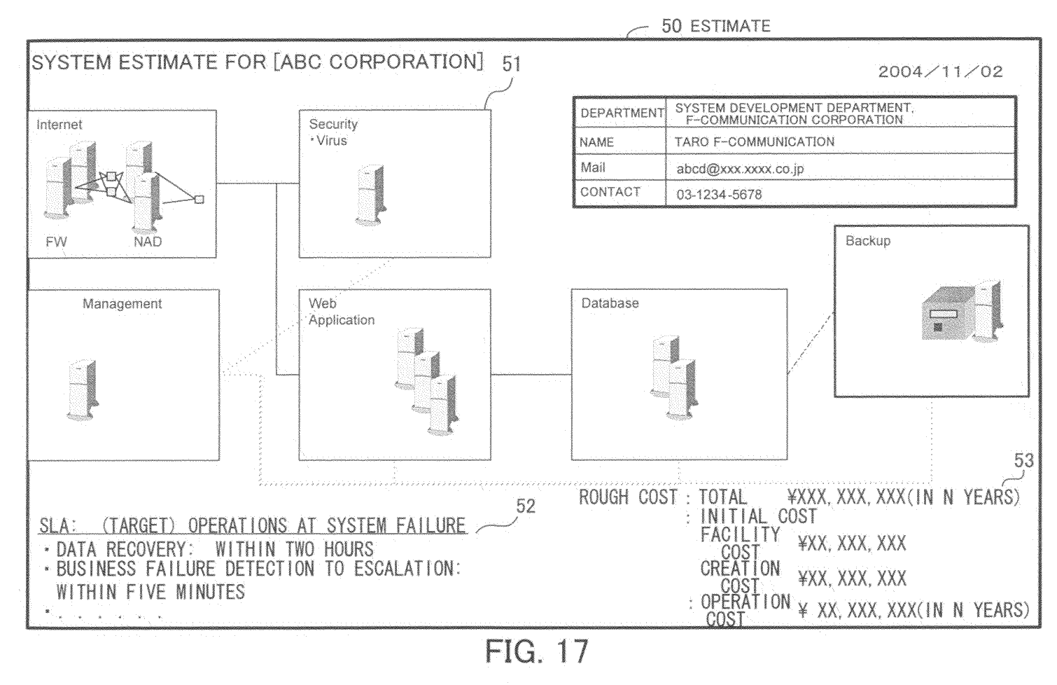

FIG. 17 is a view showing an example estimate of the entire system. An estimate 50 includes a block diagram 51 showing a system configuration, a service-quality guarantee contents 52, and a rough cost 53.

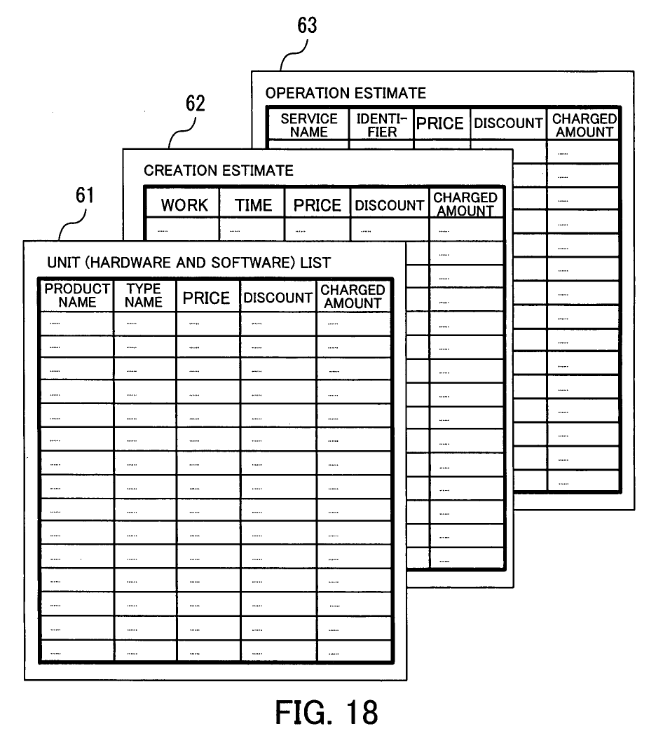

FIG. 18 is a view showing example detailed estimates. As detailed estimates, a unit list 61, a creation estimate 62, and an operation estimate 63 are shown. The unit list 61 indicates the product name, type name, price, discount, and charged amount of each of the hardware resources and software resources introduced into the system. The creation estimate 62 indicates the content, work period, price, discount, and charged amount of work items in system creation. The operation estimate 63 indicates the name, identifier, price, discount, and charged amount of services for maintenance and operations.

As described above, the fixed cost and variable cost of each apparatus and the fixed cost and variable cost of the entire proposed system are calculated according to the contents input by the user and outputted to clearly indicate the cost for system investment. As a result, the user can easily select a system configuration advantageous in terms of cost-effectiveness.

The above-described processing functions can be implemented by a computer. In that case, a program describing the processing contents of the functions which the computer should have is provided. When the computer executes the program, the processing functions are implemented in the computer. The program, which describes the processing contents, can be recorded in a computer-readable recording medium. Such computer-readable recording media includes magnetic recording devices, optical disks, magneto-optical recording media, and semiconductor memories. The magnetic recording devices include hard disk drives (HDDs), flexible disks (FDs), and magnetic tape. The optical disks include DVDs (digital versatile discs), DVD-RAMs (DVD random access memories), CD-ROMs (compact disc read only memories), CD-Rs (CD recordables), and CD-RWs (CD rewritables). The magneto-optical recording media include MOs (magneto-optical disks).

To distribute the program, portable recording media such as DVDs and CD-ROMs having recorded the program are, for example, sold. The program can be stored in a storage device of a server computer and transferred to another computer from the server computer through a network.

For example, the computer, which executes the program, stores the program recorded in a portable recording medium or the program transferred from the server computer, in its storage device. The computer reads the program from its storage device and executes processing according to the program. The computer can read the program directly from the portable recording medium and execute the processing according to the program. Every time the program is transferred from the server computer, the computer can execute the processing according to the received program.

In the present invention, a list of resource information that includes the fixed cost and variable cost of each resource is outputted, the selection of resources to be employed in a computer system is received, and the fixed costs and variable costs of the selected resources are summed up and outputted. With this, at a stage when the system is designed, the fixed cost and variable cost of the computer system proposed can be easily recognized.

The foregoing is considered as illustrative only of the principles of the present invention. Further, since numerous modifications and changes will readily occur to those skilled in the art, it is not desired to limit the invention to the exact structure and applications shown and described, and accordingly, all suitable modifications and equivalents may be regarded as falling within the scope of the invention in the appended claims and their equivalents.

What is claimed is:

1. A computer-readable recording medium having computer-executable instructions for performing steps for supporting design of a computer system, the steps comprising:
(1) receiving a function selected and input, to be applied to the computer system;
(2) extracting resource information related to a resource available for implementing the selected function from a resource information table, the resource information table having resource information that includes the fixed cost and variable cost of each resource;
(3) receiving a resource selected and input, to be employed in the computer system to be created, from the extracted resource information; and
(4) summing up the fixed cost and variable cost of the selected resource information to indicate the fixed cost and variable cost of the computer system to be created.

2. The computer-readable recording medium according to claim 1, further comprising (5) outputting a block diagram representing a function constituting the computer system, by a plurality of functional blocks, wherein said step (1) receives the function selected, by receiving a desired functional block selected and input from the block diagram outputted at said step (5).

3. The computer-readable recording medium according to claim 2, wherein said step (5) outputs the block diagram based on received input basic parameter indicating a function which a user wants to introduce into the computer system.

4. The computer-readable recording medium according to claim 1, wherein said step (5) outputs a graph representing the fixed cost and variable cost of the extracted resource information with the vertical axis indicating a total cost and the horizontal axis indicating an operation period.

5. The computer-readable recording medium according to claim 1, wherein said step (2) further outputs the extracted resource information with information indicating a risk in an operation being attached.

6. The computer-readable recording medium according to claim 5, wherein, when the extracted resource information is a data-backup resource, said step (5) further calculates a backup period and a recovery period from a backup amount and resource performance in the computer system to be created and outputs the extracted resource information with the backup period and the recovery period.

7. A computer-based method for supporting design of a computer system, comprising the steps of:
(1) receiving a function selected and input, to be applied to the computer system;
(2) extracting resource information related to a resource available for implementing the selected function from a resource information table, the resource information table having resource information that includes the fixed cost and variable cost of each resource;
(3) receiving a resource selected and input, to be employed in the computer system to be created, from the extracted resource information; and
(4) summing up the fixed cost and variable cost of the selected resource information to indicate the fixed cost and variable cost of the computer system to be created.

8. The computer-based method according to claim 7, further comprising the step of (5) outputting a block diagram representing a function constituting the computer system, by a plurality of functional blocks, wherein said step (1) receives the function selected, by receiving a desired functional block selected and input from the block diagram outputted at said step (5).

9. The computer-based method according to claim 8, wherein said step (5) outputs the block diagram based on received input basic parameter indicating a function which a user wants to introduce into the computer system.

10. The computer-based method according to claim 7, wherein said step (5) outputs a graph representing the fixed cost and variable cost of the extracted resource information with the vertical axis indicating a total cost and the horizontal axis indicating an operation period.

11. The computer-based method according to claim 7, wherein said step (2) further outputs the extracted resource information with information indicating a risk in an operation being attached.

12. The computer-based method according to claim 11, wherein, when the extracted resource information is a data-backup resource, said step (5) further calculates a backup period and a recovery period from a backup amount and resource performance in the computer system to be created and outputs the extracted resource information with the backup period and the recovery period.

13. A system-design support apparatus for supporting design of a computer system, comprising:
function-selection receiving means for receiving a function selected and input, to be applied to the computer system;
resource output means for extracting resource information related to a resource available for implementing the selected function from a resource information table, the resource information table having resource information that includes the fixed cost and variable cost of each resource;
resource-selection receiving means for receiving a resource selected and input, to be employed in the computer system to be created, from the extracted resource information; and
cost output means for summing up the fixed cost and variable cost of the selected resource information to indicate the fixed cost and variable cost of the computer system to be created.

14. The system-design support apparatus according to claim 13, further comprising block-diagram output means for outputting a block diagram representing a function constituting the computer system, by a plurality of functional blocks, wherein said function-selection receiving means receives the function selected, by receiving a desired functional block selected and input from the block diagram outputted by said block-diagram output means.

15. The system-design support apparatus according to claim 14, wherein said block-diagram output means outputs the block diagram based on received input basic parameter indicating a function which a user wants to introduce into the computer system.

16. The system-design support apparatus according to claim 13, wherein said block-diagram output means outputs a graph representing the fixed cost and variable cost of the extracted resource information with the vertical axis indicating a total cost and the horizontal axis indicating an operation period.

17. The system-design support apparatus according to claim 13, wherein said resource output means further outputs the extracted resource information with information indicating a risk in an operation being attached.

18. The system-design support apparatus according to claim 17, wherein, when the extracted resource information is a data-backup resource, said block-diagram output means further calculates a backup period and a recovery period from a backup amount and resource performance in the computer system to be created and outputs the extracted resource information with the backup period and the recovery period.
